(19) United States
(12) Patent Application Publication
(10) Pub. No.: US 2009/0158216 A1
(43) Pub. Date: Jun. 18, 2009

(54) METHOD AND SYSTEM FOR SETTING UP A COMPUTER SYSTEM AT STARTUP

(75) Inventors: Guoxuan Zhang, San Diego, CA (US); Robert Cowie, Escondido, CA (US); Tom Lam, Chula Vista, CA (US); Don Ngueyn, San Marcos, CA (US); Tam Dao, San Marcos, CA (US)

Correspondence Address: SONY C/O MURABITO, HAO & BARNES LLP, TWO NORTH MARKET STREET, THIRD FLOOR, SAN JOSE, CA, 95113, US

(73) Assignees: SONY CORPORATION, Tokyo (JP); SONY ELECTRONICS, INC., Parkridge, NJ (US)

(21) Appl. No.: 12/329,175

(22) Filed: Dec. 5, 2008

Related U.S. Application Data
(60) Provisional application No. 61/007,647, filed on Dec. 14, 2007.

(51) Int. Cl. G06F 3/048

(52) U.S. Cl. 715/835

(57) ABSTRACT

A graphical user interface (GUI) for setting up a computer system at startup. The GUI may include a first plurality of on-screen selectable icons, wherein each of the first plurality of on-screen selectable icons is associated with at least one respective setup procedure that when invoked causes a processor to execute an associated setup functionality. The GUI further includes a first visual indicator operable to identify one of the first plurality of on-screen selectable icons responsive to a user selection thereof. A second visual indicator may be used to identify a completion of a setup procedure associated with the user selection of the one of the first plurality of on-screen selectable icons. The GUI also includes a plurality of on-screen navigational icons for navigating through the first plurality of on-screen selectable icons, for canceling a selection and for exiting a startup user experience.

### RELATED APPLICATIONS

This application claims the benefit and priority to a provisional application Ser. No. 61/007,647 with attorney docket No. 50×9271.01, inventors Zhang et al., entitled “ENHANCE PC SETUP EXPERIENCE FROM STARTUP” that was filed on Dec. 14, 2007 and assigned to the same assignee. The above-cited provisional application is incorporated herein in its entirety.

### TECHNICAL FIELD

Embodiments of the present invention relate to the field of computer systems. More particularly, embodiments of the present invention relate to methods and system for setting up a personal computer at startup.

### BACKGROUND ART

In general, personal computers (PC) are setup at startup when booting up for the first time. For example, network connections must be setup in order to access the Internet, email, etc. Other aspects of a PC are similarly setup at startup, e.g., security, firewalls, applications, registrations, etc.

Multiple pop-ups windows may be used to manually setup a PC at startup when booting up for the first time. For example, multiple pop-ups can be used to guide a user through a series of setup procedures for setting up the PC. Unfortunately, providing pop-ups in the conventional method lacks the ability to track setup processes that have been completed versus those that are yet to be completed. As such, setting up a PC at startup may become a daunting task especially for novice computer users.

Furthermore, setting up a PC at startup using pop-up windows in the conventional manner lacks organization and as a result fails to be intuitive. Presenting multiple unrelated pop-ups at the same time may be disorganized and may not provide users with adequate information regarding the type of setup that the pop-up is concerned with. For example, one pop-up may be used to setup firewalls, a second pop-up may be used to setup anti-viruses, both of which are concerned with security, and a third pop-up may be used to setup wireless line that is concerned with networking. A problem arises because security and networking are unrelated and providing pop-ups without a particular organization may lead to confusion.

In one conventional method, a user may be required to actively navigate to the control panel in order to launch the appropriate setup procedure. For example, the control panel may be used to launch and setup networks in order to gain access to the Internet. Unfortunately, requiring a user to actively setup the PC at startup by navigating to the control panel and launching the appropriate setup procedure may be inconvenient especially for novice computer users that may be unaware of such requirement.

### SUMMARY

Accordingly, a need has arisen to provide a user friendly method to setup a PC at startup, e.g., when booting up for the first time. More particularly, a need has arisen to provide a computerized graphical user interface (GUI) that organizes setup procedures for a PC at startup. It will become apparent to those skilled in the art in view of the detailed description of the present invention that the embodiments of the present invention remedy the above mentioned needs and provide the above referenced advantages.

In one embodiment, a GUI with a first plurality of on-screen selectable icons is provided at startup. Each of the first plurality of on-screen selectable icons represents at least one setup procedure for a PC at startup. Accordingly, in response to a user selection of one icon of the first plurality of on-screen selectable icons, an associated setup procedure for setting up an aspect of the PC may be launched by a processor. It is appreciated that each of the first plurality of on-screen selectable icons may group setup procedures related to a given feature. For example, a wireless connection, a LAN connection and a DSL connection may be represented by a “network connections” selectable icon. It is appreciated that the GUI may further comprise navigational icons for 1) navigating between the first plurality of on-screen selectable icons, 2) canceling a selection, 3) saving and 4) exiting the setup procedure, for instance.

According to one embodiment, a first visual indicator may be displayed in response to a user selecting one of the first plurality of on-screen selectable icons in order to identify the icon as being selected. For example, an on-screen selectable icon may become highlighted when a user selects the on-screen selectable icon. It is appreciated that in some embodiments, the selected on-screen icon may start flashing, the text in the icon may become bold, the font of the text in the icon may be changed and/or a mark, e.g., a checkmark, may be displayed in close proximity of the icon. It is appreciated that a second plurality of on-screen selectable icons may be displayed in response to a user selection of one of the first plurality of on-screen selectable icons. The user may in turn select one of the second plurality of on-screen selectable icons. A visual indicator may be displayed responsive to selecting one of the second plurality of on-screen selectable icons to identify the selected icon as being selected. The visual indicator for identifying one of the second plurality of on-screen selectable icons may be the same as the first visual indicator or it may be different than the first visual indicator used to identify one of the first plurality of on-screen selectable icons.

It is appreciated that a visual indicator may be displayed to indicate that a setup procedure associated with the selected icon from the first plurality of on-screen selectable icons and/or a selected icon from the second plurality of on-screen selectable icons has been completed. The visual indicator for indicating the completion of the setup procedure may be the same as the first visual indicator or it may be different than the first visual indicator. For example, the visual indicator for identifying the completion of the setup procedure may be a checkmark displayed in close proximity of the completed icon associated with the setup procedure.

More specifically, a graphical user interface (GUI) for setting up a personal computer (PC) at startup may include a first plurality of on-screen selectable icons. Each of the first plurality of on-screen selectable icons may be associated with at least one respective setup procedure at startup that when invoked causes a processor to launch an associated setup procedure. A first visual indicator may be displayed that is operable to identify one of the first plurality of on-screen selectable icons responsive to a user selection thereof. According to one embodiment, a second visual indicator may be displayed that is operable to identify a completion of a setup procedure at startup associated with the user selection of one of the first plurality of on-screen selectable icons. The GUI may further include a plurality of on-screen navigational icons for navigating through the first plurality of on-screen selectable icons, canceling a selection and exiting said startup.

According to one embodiment, the GUI may further include a second plurality of on-screen selectable icons associated with the user selection of one of the first plurality of on-screen selectable icons. In one exemplary embodiment, each of the second plurality of on-screen selectable icons is associated with a setup procedure at startup. A third visual indicator may be displayed that is operable to identify one of the second plurality of on-screen selectable icons responsive to a user selection thereof. It is appreciated that the third visual indicator may be the same as the first visual indicator.

In one embodiment, the GUI may further display a third visual indicator operable to identify a completion of a setup procedure at startup associated with the user selection of one of the second plurality of on-screen selectable icons. It is appreciated that in one exemplary embodiment, the third visual indicator may be the same as the second visual indicator. It is appreciated that the system may store the setup and track the completed setup procedures and those that are yet to be completed. As such, when the user re-runs the startup software, only those setup procedures that are not completed are executed, thereby saving the user the need to remember which setup procedures need to be executed.

According to one embodiment, the visual indicators may be selected from a group consisting of flashing icons, highlighted icons, bolded texts within icons, change of text fonts within icons and a checkmark in close proximity of the first plurality of on-screen selectable icons.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIGS. 1A-1J show exemplary operations on a GUI in accordance with embodiments of the present invention.

FIG. 2A shows an exemplary system diagram in accordance with one embodiment of the present invention

FIG. 2B is a flow diagram of an exemplary computer controlled method for rendering a GUI in accordance with one embodiment of the present invention.

FIG. 3 illustrates an exemplary computer system that may serve as a platform for embodiments of the present invention.

FIGS. 4A and 4B illustrate application guide tour in accordance with embodiments of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### Notation and Nomenclature

Some portions of the detailed descriptions which follow are presented in terms of procedures, steps, logic blocks, processing, and other symbolic representations of operations on data bits that can be performed on television set memory. These descriptions and representations are the means used by those skilled in the art to most effectively convey the substance of their work to others skilled in the art. A procedure, television set executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “creating” or “transferring” or “executing” or “determining” or “instructing” or “issuing” or “clearing” or “accessing” or “aggregating” or “obtaining” or “selecting” or “calculating” or “measuring” or “querying” or “receiving” or “sending” or “providing” or “storing” or “displaying” or “rendering” or the like, refer to the action and processes of a television set, or similar electronic computing device, that manipulates and transforms data represented as physical (electronic) quantities within the television set's registers and memories into other data similarly represented as physical quantities within the television set memories or registers or other such information storage, transmission or display devices.

### A Method and System for Setting Up a Computer System at Startup

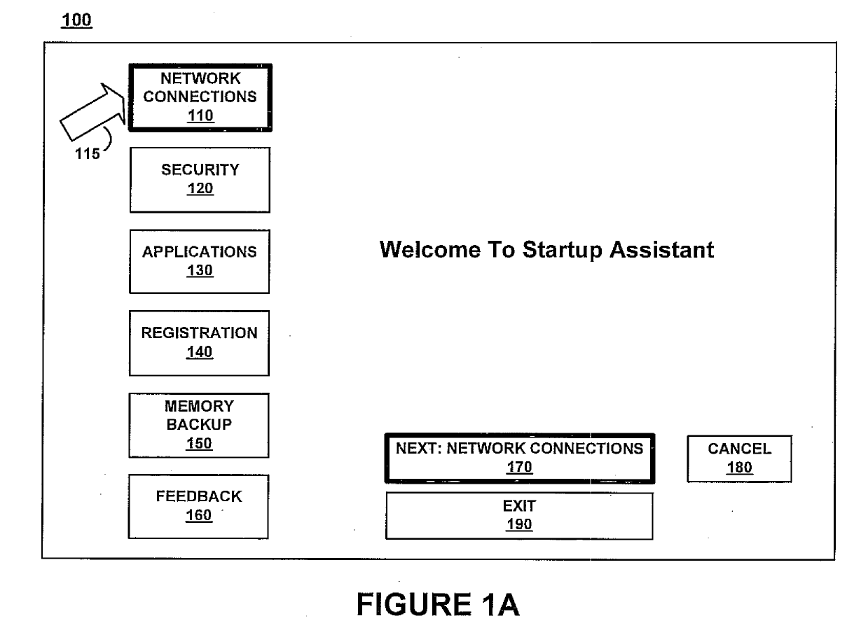

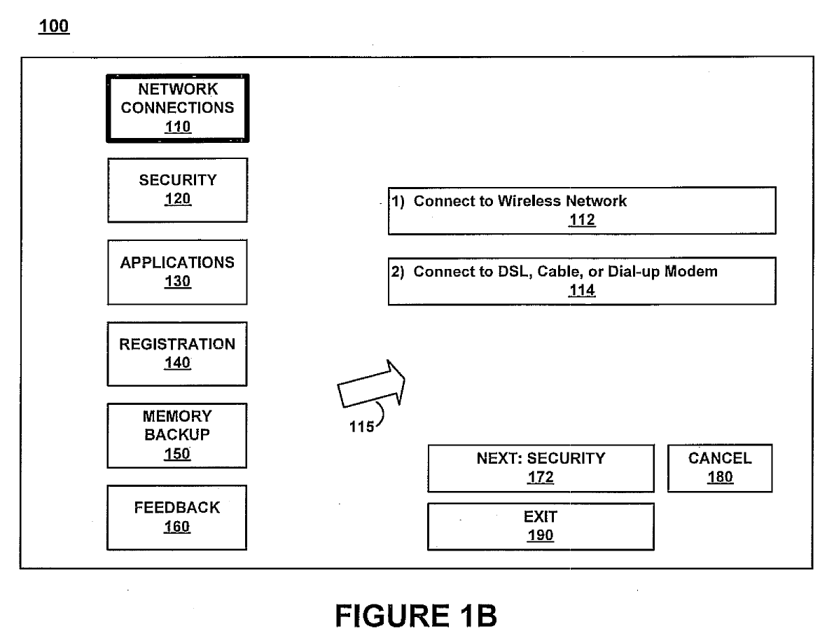

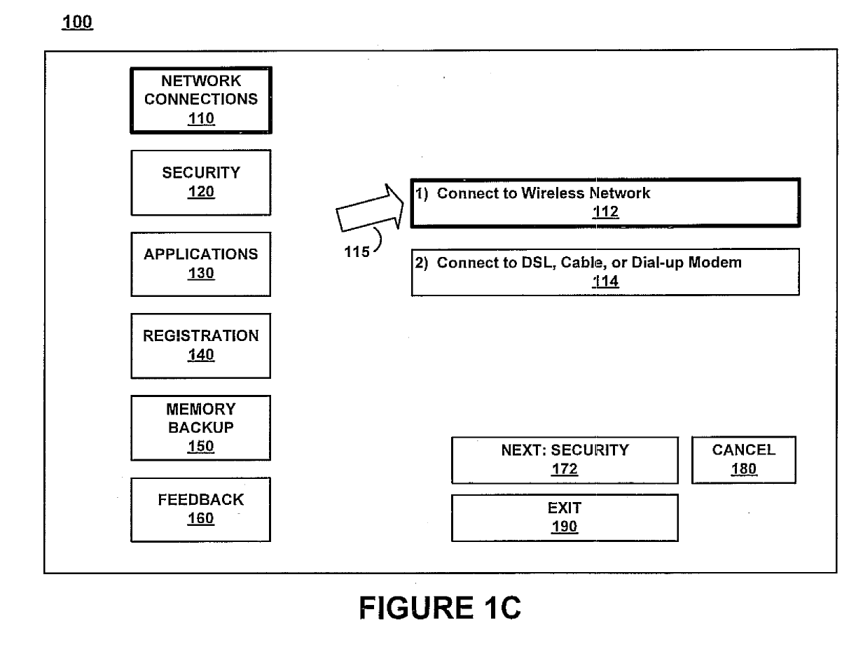

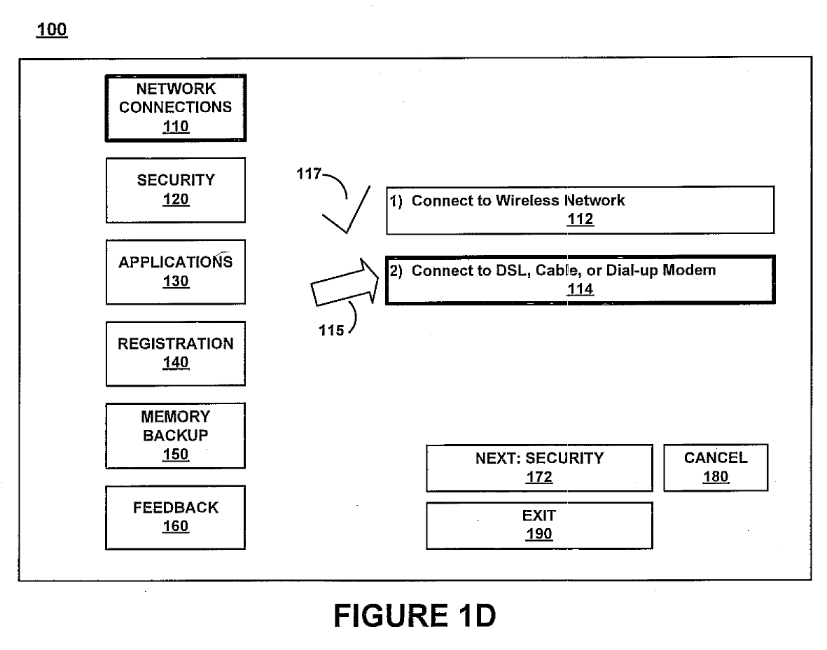

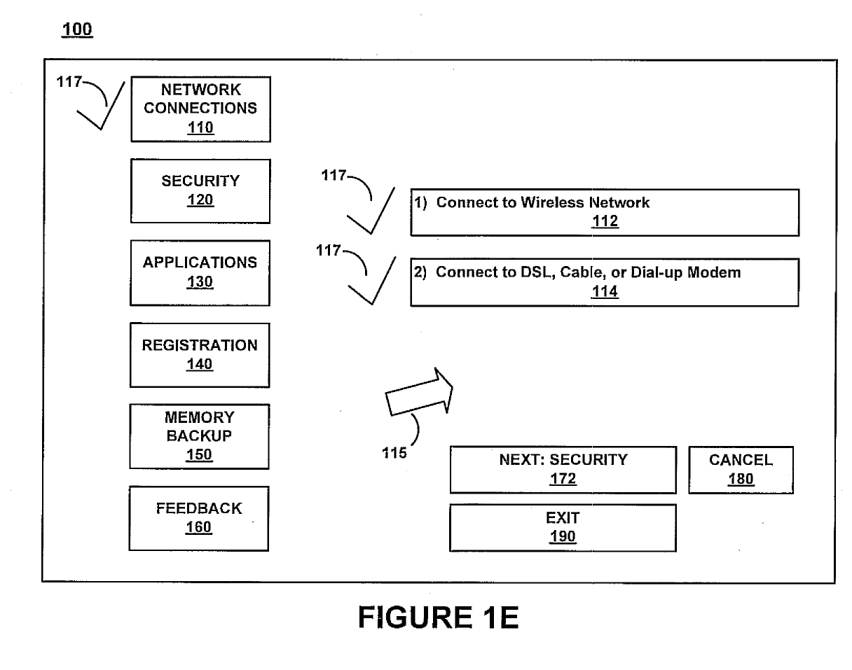

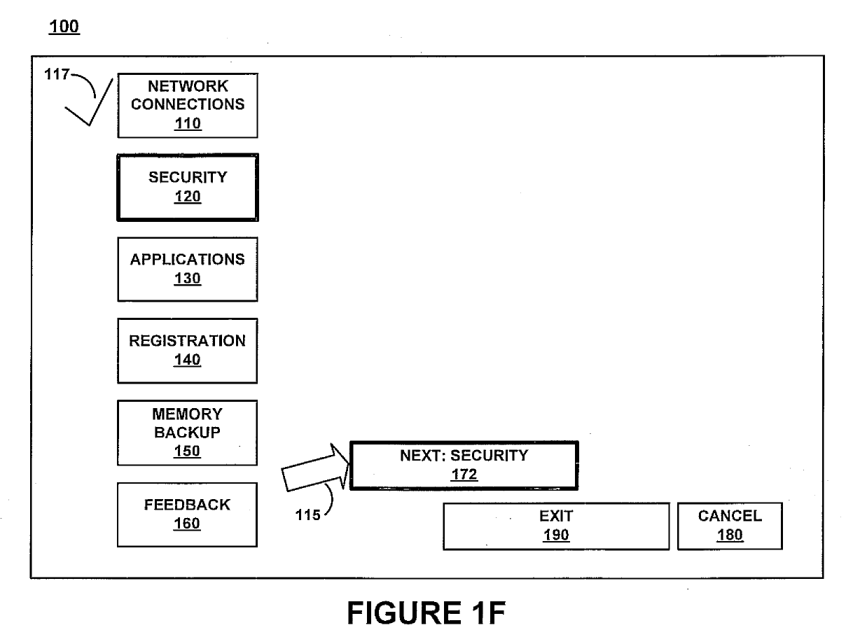

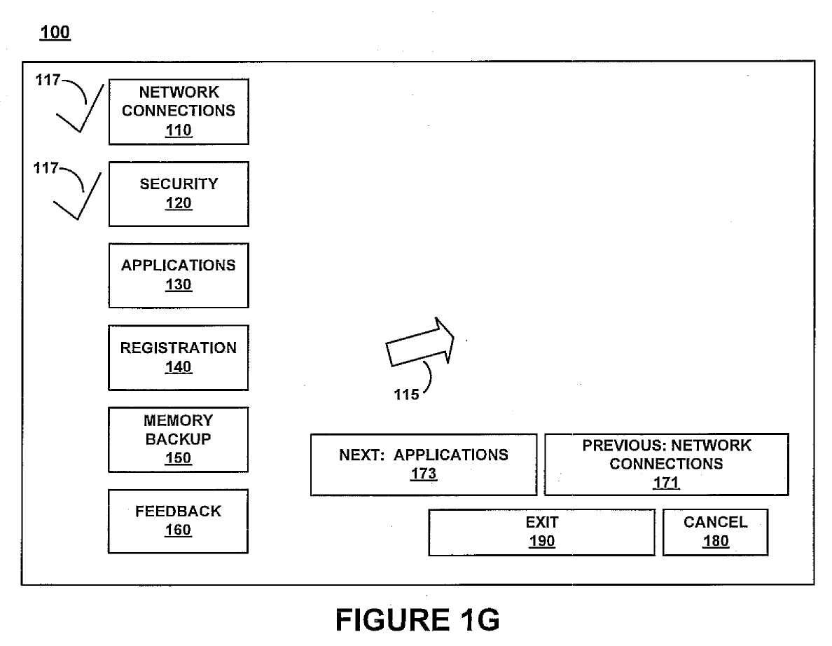

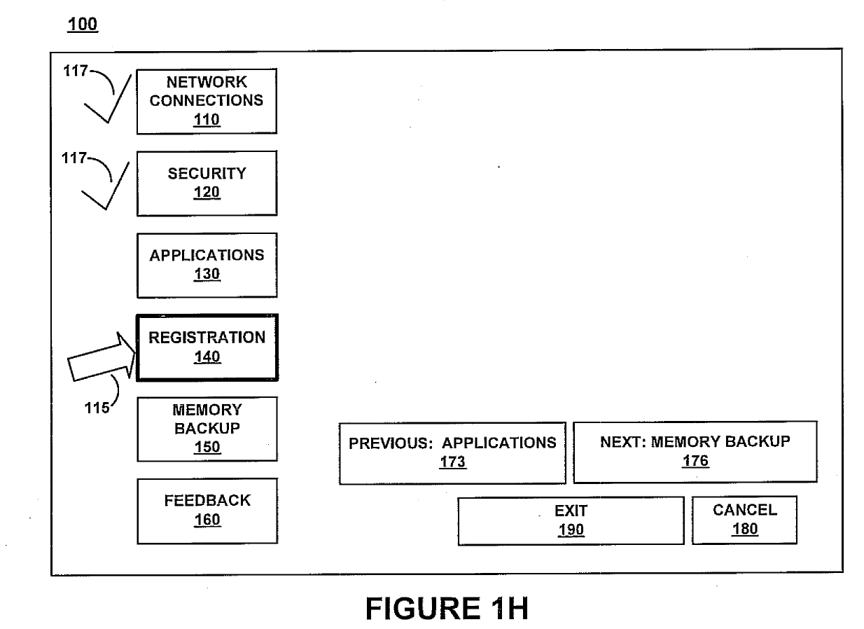

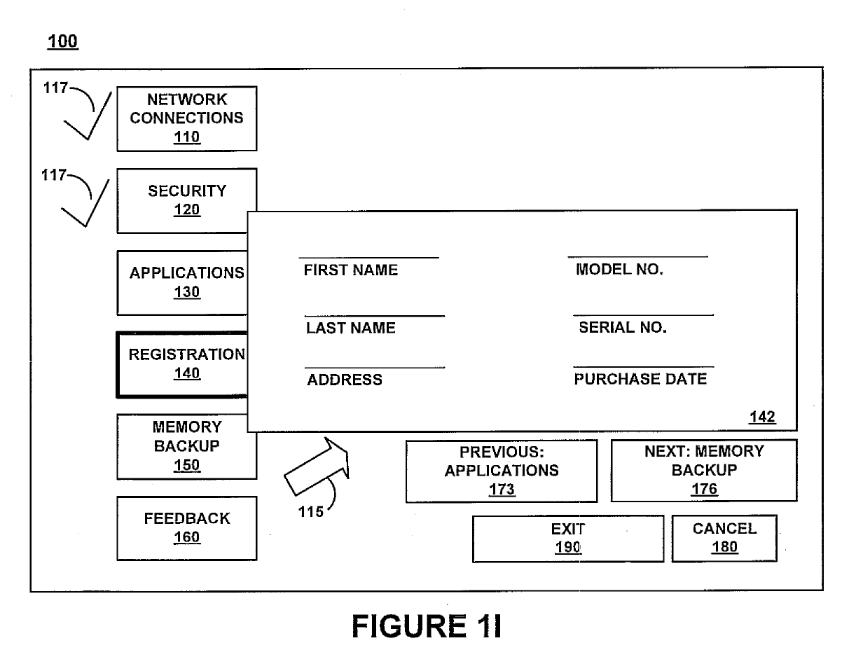

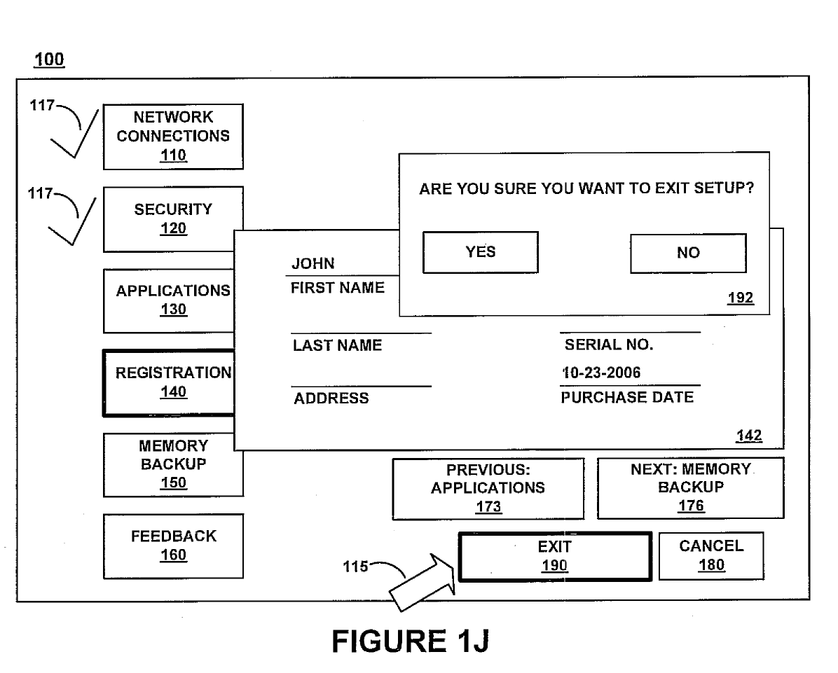

Referring now to FIGS. 1A-1J, exemplary operations on a GUI 100 in accordance with embodiments of the present invention are shown. The GUI 100 may include a plurality of on-screen selectable icons, e.g., network connections 110, security 120, applications 130, registration 140, memory backup 150, feedback 160, etc. that become displayed on the target computer system upon startup. A user selection of on-screen selectable icons may provide display of additional on-screen selectable icons and/or cause a processor to launch a setup procedure associated with the selected icon. On-screen selectable icons may be selected by the user interfacing any selection device, e.g., a mouse, a keyboard, a joystick, etc., that controls the movement of a cursor 115 on a display screen.

The GUI 100 may further include a plurality of navigational icons for enabling a user to navigate between various setup procedures. For example, the plurality of navigational icons may include a next 170 icon, a cancel 180 icon and an exit 190 icon. The next 170 icon enables the user to navigate to the next setup procedure, e.g., network connections 110. The cancel 180 icon may cancel the last selection and the exit 190 icon may save the current state of the setup procedure before exiting the setup procedure. It is appreciated that the navigational icons shown are exemplary and are not intended to limit the scope of the present invention.

Each of the on-screen selectable icons may be associated with at least one setup procedure or collection of startup procedures of a common type. For example, network connections 110 icon may be associated with a setup procedure associated with the wireless connection, wire line connection, wide area network (WAN), etc. In one embodiment, the security 120 icon may be associated with the setup procedure of security features of the PC at startup, e.g., antivirus, firewalls, spyware, fingerprint sensor, biometric information, encryption, password, etc.

According to one embodiment, the applications 130 icon may be associated with a setup procedure of various application programs of a same type. For example, setup of application programs may include setup procedure for Microsoft Word™, Microsoft Excel™, Quickbook™, iTunes™, etc. The registrations 140 icon may be associated with the setup procedure to register the PC and/or applications with various vendors. For example, registrations 140 may automatically pre-populate a form with user information, product information and/or request the user to enter the information manually in a form, e.g., online form, before submission of the information to the appropriate vendor.

In one embodiment of the present invention, the memory backup 150 icon may be associated with a setup procedure to transfer information between a computing device ad the current PC, e.g., to transfer information from an old PC to the new PC. Optionally, the feedback 160 icon may be associated with user feedback. For example, in response to a user selection of the feedback 160 icon, a feedback form may be presented to the user for input. The feedback form may provide multiple choice questions with possible answers to the user and/or enable a user to enter an open ended feedback that can be forwarded via the Internet, for instance.

It is appreciated that the setup procedure and the user interaction with the setup procedure may be tracked. A feedback form may be presented after certain period of time, e.g., 90 days after setup procedure is launched. The feedback form may be pre-populated with the user specific information to relieve the user of duplicating that information. The form enables the user to provide feedback regarding various aspects of the setup procedure. The feedback provided may be transmitted to a database where it may be stored and analyzed to provide various statistical information, e.g., percentage of problems with respect to a given setup procedure, percentage of customer satisfaction, percentage of customers using the setup procedure, etc. Accordingly, the statistical analysis may be used to improve the setup procedure and to improve customer satisfaction.

In one exemplary embodiment, the user may wish to step through the setup procedure in the order presented. For example, the user may simply move the cursor 115 to the network connection 110 and/or the next: network connections 170 icon. A visual indicator may be displayed to identify the user selection, e.g., network connections 110 and next: network connections 170 may become highlighted. It is appreciated that the visual indicator to identify the user selection may be any kind of visual indicator, e.g., changing the font of the text within the selected icon, flashing the selected icon, bolding the font of the text within the selected icon, displaying a checkmark in close proximity of the selected icon, etc. As such, it is appreciated that the visual indicators shown and described are exemplary and are not intended to limit the scope of the present invention.

Referring now to FIG. 1B, a plurality of additional on-screen selectable icons are shown that are of a common type and are displayed in response to a user selecting network connections 110 in accordance with one embodiment of the present invention. For example, in response to a user selecting the network connections 110, additional related on-screen selectable icons 112 and 114 are displayed. The on-screen selectable icon 112 may be associated with a setup procedure related to a wireless network connection. The on-screen selectable icon 114 may be associated with a setup procedure related to DSL, Cable, or Dial-up Modem connections. Selection of the on-screen selectable icons 112 or 114 may cause the processor to launch the setup procedure of the PC associated with the selected icon.

It is appreciated that additional setup procedures associated with the network connections 110 may be displayed responsive to a user selection of the network connections 110. As such, the display of the on-screen selectable icons 112 and 114 are exemplary and not intended to limit the scope of the present invention. Furthermore, a user selection may directly launch a setup procedure associated with the selected on-screen selectable icon if the on-screen selectable icon has only one setup procedure associated therewith.

It is appreciated that a user interface device may be used to control the cursor 115 to select the on-screen selectable icons 112 or 114. It is further appreciated that the selection of the network connections 110 may cause the next icon 170 of the navigational icon to be updated to reflect the next setup procedure to be launched as the security 172 setup procedure. As such, selecting the next icon 172 may cause the processor to launch the security setup procedure or additional on-screen selectable icons associated therewith.

Referring now to FIG. 1C, a user selection to setup a wireless network in accordance with one embodiment of the present invention is shown. For example, the user may select to setup the wireless network at startup by navigating the cursor 115 to select the icon 112. It is appreciated that the user may select any one of the on-screen selectable icons. As such, selecting icon 112 is exemplary and should not be construed as limiting the scope of the present invention. For example, the user may select the memory backup 150 icon or may select the 114 icon to setup the DSL, cable or dial-up modem connections, for instance.

In response to making a selection, the selected icon may be identified with a visual indicator or attribute. It is appreciated that the visual indicator to identify the selection of the icon 112 may be the same as the visual indicator to identify the selection of the network connections 110 or it may be different. For example, the visual indicator used to identify the user selected icon may highlight the selected icon, change the font for the text within the selected icon, bold the text within the selected icon, flash the selected icon, display a mark, e.g., checkmark, in close proximity of the selected icon, etc. In response to the user selection, a setup procedure associated with the selected icon may be launched by the processor. For example, the processor may launch the setup procedure associated with the wireless network connection. It is appreciated that a setup procedure launched by the processor may include a GUI with step by step instructions to setup a selected feature.

Referring now to FIG. 1D, a visual indicator identifying a completion of a setup procedure in accordance with one embodiment of the present invention is shown. For example, when a user has completed the setup procedure associated with the wireless network, the on-screen selectable icon corresponding to the setup procedure of the wireless network may be identified by a visual indicator, e.g., a checkmark 117.

It is appreciated that the visual indicator identifying a completion of a setup procedure may be any visual indicator. For example, the visual indicator used to identify a completion of a setup procedure may be by highlighting the icon with a different color than the highlighting used to identify a selection of an on-screen selectable icon, changing the font for the text within the icon, displaying an asterisk in close proximity of the icon, etc. It is further appreciated that the visual indicator used to identify the completion of a setup procedure may be the same as the visual indicator used to identify the selection of an icon associated with a setup procedure.

Referring still to FIG. 1D, the user may select the on-screen selectable icon 114 in order to launch the setup procedures associated with the setup of the DSL, cable or dial-up modem. In response to selecting the icon 114, the selectable icon 114 may be highlighted as shown. As described above, the visual indicator used to identify a user selection may be any kind of visual indicator. For example, the visual indicator may be by flashing the icon, changing the font of the text within the icon, bolding the text within the icon, etc.

It is appreciated that the user may choose not to select the selectable icon 114 and go through the remaining elements of the setup procedure. For example, without selecting the icon 114, the user may select the security 120 icon to launch the setup procedures associated with the security features of the PC at startup. As such, the order of which the user chooses to go through the setup procedures is exemplary and is not intended to limit the scope of the present invention. Moreover, it is appreciated that the user may wish not to setup a given setup feature, e.g., skipping the setup procedure associated with the DSL connection.

Upon launching the setup procedure associated with the selected icon 114, the user may go through all the steps of the setup procedure and complete the setup procedure. Referring now to FIG. 1E, a visual indicator, e.g., a checkmark 117, to identify an icon associated with the completed setup procedure in accordance with one embodiment of the present invention is shown. For example, a checkmark 117 may be displayed in close proximity of the icon 114 when the setup procedure associated with the DSL, cable or dial-up modem connections, are completed. As described above, the visual indicator for identifying completion of a setup procedure may be any kind of visual indicator. As such, the use of a checkmark 117 as a visual indicator is exemplary and should not be construed as limiting the scope of the present invention.

Upon completion of the setup procedure associated with the DSL, cable or dial-up modem connection, all the setup procedures associated with the network connections 110 are completed. As such, a visual indicator for identifying completion of setup procedures associated with the network connections 110 may be displayed in close proximity of the network connections 110. In this exemplary embodiment, the visual indicator may be a checkmark but as described above the visual indicator may be any visual indicator.

Referring now to FIG. 1F, a user selection of a next setup procedure in accordance with one embodiment of the present invention is shown. For example, the user may select the next setup procedure associated with security features of the PC at startup. As such, the user may select the security feature by either selecting the next 172 navigational icon or by directly selecting the security 120 icon. In response to a user selection to setup the security features, additional on-screen selectable icons associated with various setup procedures may be displayed. For example, additional on-screen selectable icons may include an icon for antivirus, an icon for firewalls, an icon for spyware, an icon for biometric information, an icon for password protection, etc. However, a setup procedure may be directly launched if the security feature has only one setup procedure.

Referring now to FIG. 1G, a visual indicator 117 used to identify the completion of a setup procedure associated with security feature of the PC at startup in accordance with one embodiment of the present invention is shown. A visual indicator, e.g., a checkmark 117, may be displayed in close proximity of the security 120 icon, which is associated with the complete security setup procedures of the PC at startup. The visual indicator for identifying the completion of a setup procedure may be any kind of visual indication, e.g., flashing icon, as described above.

It is appreciated that the next 173 navigational icon may be updated to reflect the next setup procedure to be launched. For example, the next setup procedure to be launched may be associated with applications. It is appreciated that the navigational icons may now include the previous setup procedure icon 171 that is associated with the network connections 110, which is now completed.

Referring now to FIG. 1H, the user may select the registration 140 icon and skip the setup procedures associated with applications 130. Accordingly, the registration 140 icon may be visually indicated as being selected, e.g., highlighted. However, as described above, the visual indicator may be any kind of visual indicator, e.g., flashing icon, changing the font of the text within the icon, etc. It is appreciated that the next navigational icon 176 may be updated to reflect the next setup procedure to be launched as the setup procedure following the registration 140 setup procedure. As such, the next navigational icon 176 points to the setup procedure associated with memory backup. It is also appreciated that the previous navigational icon 173 may be updated to reflect the setup procedure preceding the registration 140 setup. For example, the previous navigational icon 173 may be updated to reflect the setup procedures associated with applications, preceding the registrations 140 setup procedures.

Referring now to FIG. 1I, a registration form 142 may be presented in response to a user selection of registration 140. The registration form may include user's first name, last name, address, model number for the PC, serial number for the PC and the purchase date, for instance. It is appreciated that the registration form described is exemplary and is not intended to limit the scope of the present invention. It is appreciated that the registration form may be pre-populated with some of the above data and additional information may be provided by the user.

Referring now to FIG. 1J, a user selecting to exit the setup procedure in accordance with one embodiment of the present invention is shown. For example, the user may exit the setup procedure by selecting the exit 190 icon. Selecting the exit icon 190 may save the setup procedure up to that instant such that the user can pick up where he or she leaves off. It is appreciated that the user may be prompted to ensure that the user does in fact wish to exit the setup procedure. For example, a window 192 may be displayed asking the user whether he or she wishes to exit the setup procedure.

It is appreciated that the computer system may track the startup procedures executed successfully. Moreover, the computer system may track the startup procedures that have not been executed successfully and/or skipped by the user. Accordingly, when the user re-runs the startup software, only those setup procedures that were not successfully completed or skipped are re-run, thereby saving the user the need to remember which setup procedures need to be executed.

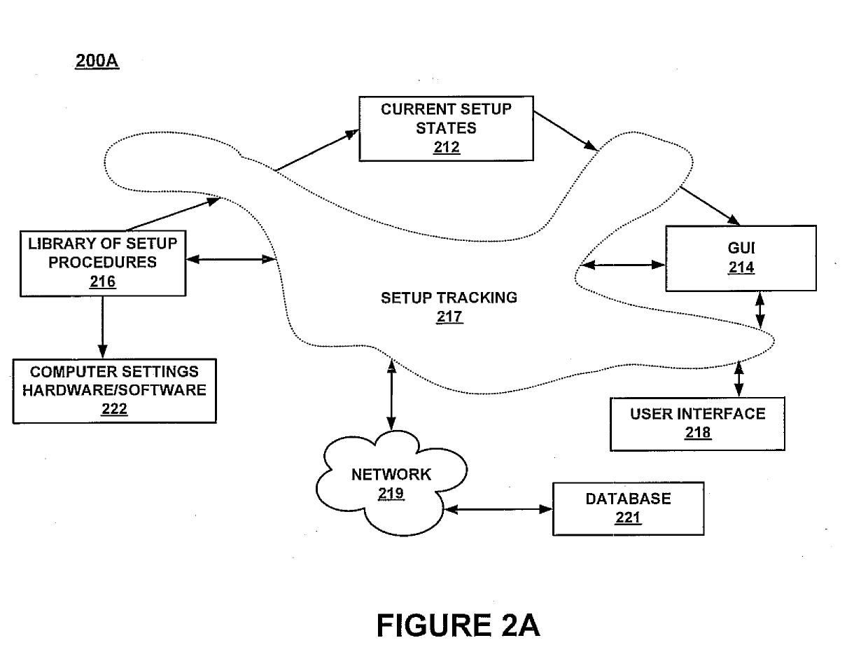

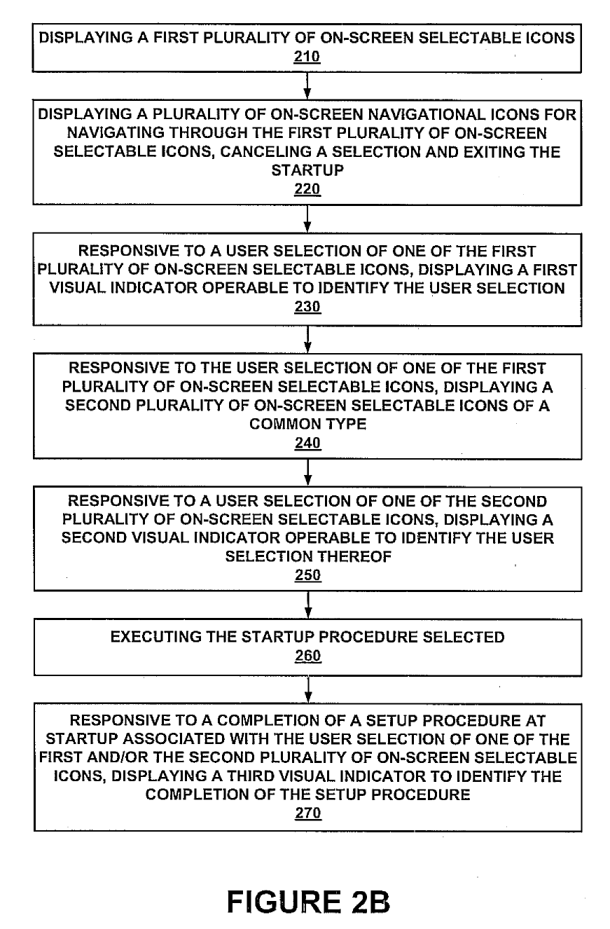

FIG. 2A shows an exemplary system diagram 200A in accordance with one embodiment of the present invention. The system 200A may include a library of setup procedures 216, current setup states 212, a GUI 214, a setup tracking 217 component, a user interface 218 and a computer settings hardware/software 222. The library of setup procedures 216 may store setup procedures to be launched and executed upon a user selection. The setup procedures stored in the library may be setup procedures associated with network connections, security, applications, registration, memory backup, etc., as described above.

The GUI 214 enables the user to interact with the library of setup procedures 216 in order to select and execute a desired setup procedure. The user may interact with the GUI 214 using the user interface 218. The user interface 218 may include a mouse, a keyboard, a joystick, etc., for instance. The library of setup procedures 216 may be in communication with the current setup states 212. The current setup states 212 may keep track of setup procedures that are successfully completed and setup procedures that are yet to be completed. The current setup states 212 may communicate the tracked information to the GUI 214. Accordingly, visual indicators may be used by the GUI 214 to reflect the tracking by the current setup states 212. Accordingly, only setup procedures that are not successfully completed or skipped are run, thereby saving the user the need to remember which setup procedures need to be executed.

It is appreciated that the library of setup procedures 216 may be coupled to computer settings hardware/software 222. Accordingly, in response to the user selection of one of the setup procedures in the library of setup procedures 216, the appropriate hardware/software coupled to the library of setup procedures 216 is setup.

It is appreciated that the setup tracking component 217 may track interaction during the setup procedure. For example, the tracking component 217 may track the user interaction via the user interface 218 with the GUI 214 and in response there to the interaction with the library of setup procedures 216. Similarly, the setup tracking component 217 may track the communication between the current setup states 212 and the GUI 214 while monitoring and tracking the interactions between the library of setup procedures 216 and the current setup states 212. The tracked information may be transmitted via a network 219 to be stored in a database 221 and analyzed. Statistical analysis of the tracked information may provide insight to improve customer satisfaction and to improve the setup procedure. For example, the percentage of customers successfully completing the setup procedure using the GUI may be tracked, percentage of customers having trouble with a given aspect of the setup procedure may be tracked, etc. Accordingly, customer satisfaction and product offerings may be improved.

FIG. 2B shows a flow diagram of an exemplary method 200B for rendering an on-screen GUI in accordance with one embodiment of the present invention. At step 210, a first plurality of on-screen selectable icons may be displayed. Each of the on-screen selectable icons may be associated with at least one setup procedure of a PC at startup. According to one embodiment, the first plurality of on-screen selectable icons may include network connections 110, security 120, applications 130, registration 140 and memory backup 150, as described and presented above. The icons may further include the feedback 160 icon, as presented and described above. It is appreciated that in response to the user selecting an icon, the processor may launch a setup procedure associated with the selected icon.

At step 220, a plurality of on-screen navigational icons, e.g., next icon, previous icon, cancel icon, exit icon, etc., as presented and described above may be displayed. Accordingly, the plurality of on-screen navigational icons may be used to navigate between various setup procedures associated with the first plurality of on-screen selectable icons.

At step 230, a first visual indicator may be displayed in response to a user selection of one of the first plurality of on-screen selectable icons. The first visual indicator may be used to identify the user selection. For example, the selected icon may be highlighted, the font of the text within the selected icon may be changed, the selected icon may be flashed, etc., as presented and described above. In one embodiment, the selected icon may be identified by displaying a first visual indicator, e.g., checkmark, asterisk, etc., in close proximity of the selected icon. As presented above, the first visual indicator may be any kind of visual indication and the highlighted icon as a form of visual indication is exemplary and not intended to limit the scope of the present invention.

At step 240, a second plurality of on-screen selectable icons of a common type may be displayed in response to a user selection of one of the first plurality of on-screen selectable icons. In one embodiment, the second plurality of on-screen selectable icons may be displayed when the selected icon that belongs to the first plurality of on-screen selectable icons has multiple setup procedures associated therewith. Otherwise, the selection of the icon from the first plurality of on-screen selectable icons may directly launch the setup procedure associated with the selected icon.

At step 250, a second visual indicator may be displayed responsive to a user selection of one of the second plurality of on-screen selectable icons. The second visual indicator may be used to identify the selected icon. It is appreciated that the selected icon may be highlighted, the font of the text within the selected icon may be changed, the selected icon may be flashed, etc., as presented and described above. In one embodiment, the selected icon may be identified by displaying a second visual indicator, e.g., checkmark, asterisk, etc., in close proximity of the selected icon. As presented above, the second visual indicator may be any kind of visual indication and the highlighted icon as a form of visual indication is exemplary and not intended to limit the scope of the present invention. It is further appreciated that the first visual indicator and the second visual indicator may be the same or they may be different from one another.

At step 260, user selection of one of the first plurality of on-screen selectable icons and/or one of the second plurality of on-screen selectable icons may cause the processor to launch and execute the setup procedure associated with the selected icon. The launched setup procedure may guide the user through the setup procedure in a chronological order.

At step 270, a third visual indicator may be displayed in response to the completion of a setup procedure at startup. It is appreciated that the completion of the setup procedure may be associated with the selected icon from the first plurality of on-screen selectable icons and/or the selected icon from the second plurality of on-screen selectable icons. The third visual indicator may be used to identify the completed setup procedures. According to one embodiment, the third visual indicator may be different from the first and the second visual indicators. However, it is appreciated that the third visual indicator may be the same as the first visual indicator and/or the second visual indicator.

It is appreciated that the selected icon associated with the completed setup procedure may be highlighted, the font of the text within the selected icon may be changed, the selected icon may be flashed, etc., as presented and described above. In one embodiment, the selected icon associated with the completed setup procedure may be identified by displaying a third visual indicator, e.g., checkmark 117, asterisk, etc., in close proximity of the selected icon associated with the completed setup procedure. As presented above, the third visual indicator may be any kind of visual indication and the checkmark as a form of visual indication is exemplary and not intended to limit the scope of the present invention.

It is appreciated that the computer system may track the startup procedures executed successfully. Moreover, the computer system may track the startup procedures that have not been executed successfully and/or skipped by the user. Accordingly, when the user re-runs the startup software, only those setup procedures that were not successfully completed or skipped are re-run, thereby saving the user the need to remember which setup procedures need to be executed.

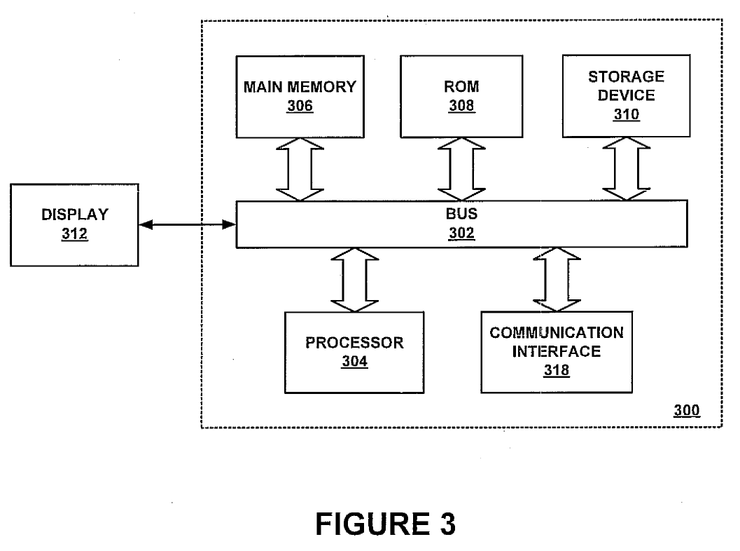

FIG. 3 illustrates an exemplary computer system 300 that may serve as a platform for embodiments of the present invention. The exemplary the computer system 300 may implement the process as shown in FIG. 2B for rendering a GUI on the computer display as shown in FIG. 1A-1J and includes a bus 302 or other communication mechanism for communicating information, and a processor 304 coupled with bus 302 for processing information.

The exemplary computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. The exemplary computer system 300 further includes a read only memory (ROM) 308 or other static storage device coupled to bus 302 for storing static information and instructions for processor 304. A non-volatile storage device 310, such as a magnetic disk or optical disk, is provided and coupled to bus 302 for storing information and instructions and may store the persistent internal queue. According to one embodiment, the instructions for implementing the virtual device may be stored on any one of the memory components (e.g., RAM, ROM, non-volatile storage device and etc.). The exemplary computer system 300 may be coupled via bus 302 to a display 312, such as a cathode ray tube (CRT), for displaying information to a computer user. According to one embodiment, the computer system 300 may send and receive messages through the network(s) via a communication interface 318.

The term “computer-readable medium” as used herein refers to any medium that participates in providing instructions to processor 304 for execution. Such a medium may take many forms, including but not limited to, non-volatile media, volatile media, and transmission media. Non-volatile media includes, for example, optical or magnetic disks, such as storage device 310. Volatile media includes dynamic memory, such as main memory 306. Transmission media includes coaxial cables, copper wire and fiber optics, including the wires that comprise bus 302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer or a television set can read.

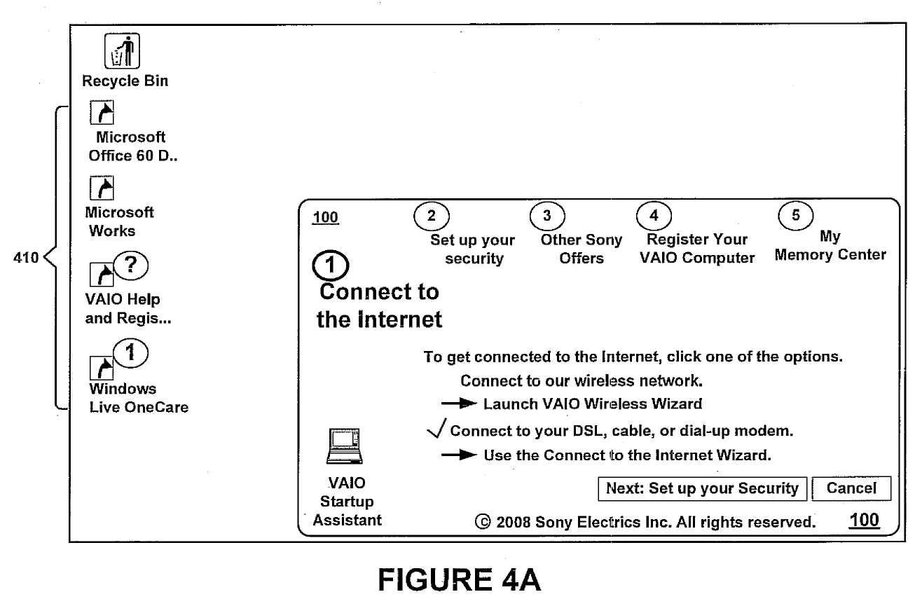

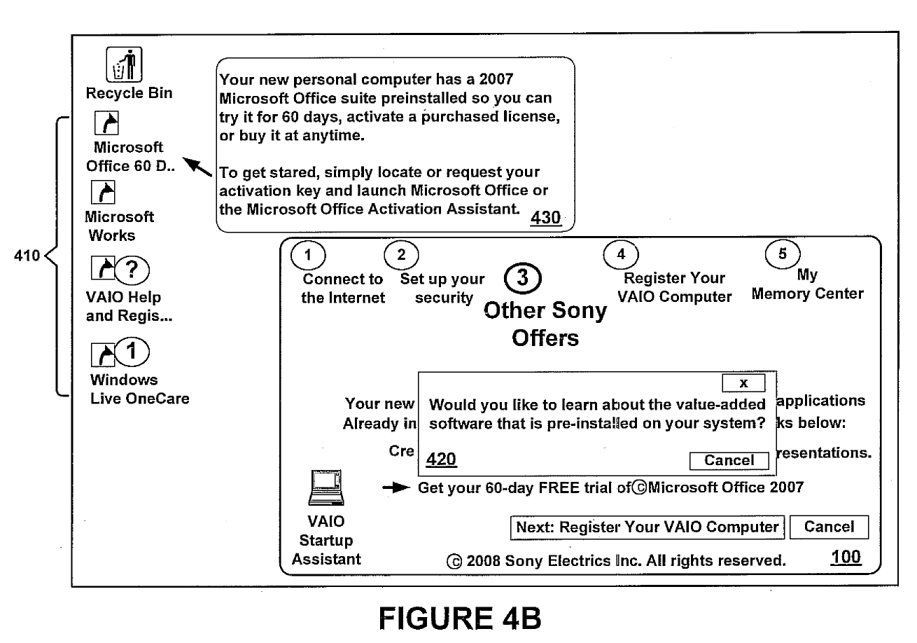

Referring now to FIGS. 4A and 4B, application guide tour in accordance with embodiments of the present invention is shown. FIG. 4A shows the GUI 100 as described above with respect to FIG. 1. Moreover, FIG. 4A shows a plurality of selectable icons 410. The plurality of selectable icons 410 are applications that may be purchased and thereafter launched. It is appreciated that according to one embodiment, the plurality of selectable icons 410 may be 50% transparent relative to the GUI 100. However, it is appreciated that any amount of transparency may be used and the use of 50% transparency is exemplary and not intended to limit the scope of the present invention.

Referring now to FIG. 4B, a user may be provided with the option of learning about applications associated with the plurality of selectable icons 410. A pop-up window 420 may be presented to the user during the setup procedure when the user launches the setup procedure associated with “other Sony offers.” It is appreciated that the pop-up window 420 may also be presented to the user during the setup procedure when the user launches the setup procedure associated with the applications 130 in FIGS. 1A-1J. The pop-up window 420 enables the user whether the user would like to learn about applications associated with the plurality of selectable icons 410. In one embodiment, the learning guide tour associated with the pop-up window 420 is launched automatically when the user does not cancel the learning guide tour. In other embodiments, the user may be required to make a selection whether to launch the learning guide tour or to resume with the setup procedure.

The user may be presented with information regarding each of the selectable icons 410 when the user launches the learning guide tour. For example, educational information regarding a given selectable icon 410 and their functionalities may be presented via a pop-up window 430 when the user moves a cursor between the plurality of the selectable icons 410. In one embodiment, when the cursor move from one selectable icon to another, the selectable icon associated with the cursor becomes non-transparent with respect to other selectable icons 410. According to one embodiment, an animation associated with the selectable icon 410 may be launched, educating the user of various functionalities of the selectable icon 410. It is appreciated that presenting various information via the pop-up windows 420 and 430 is exemplary and not intended to limit the scope of the present invention. For example, the information may be displayed in the same window, the information may be rendered via a speaker device, etc.

It is appreciated that the user may be presented with an option to purchase the application associated with each of the plurality of selectable icons 410. Furthermore, the user may choose to active a purchased license or to active a user trial offer associated with a given application. It is further appreciated that the user interaction with the application guide tour may be tracked similar to the tracking of the setup procedure, as described above. For example, user interaction with each of the plurality of selectable icons 410 may be tracked, e.g., percentage of customers launching the learning guide tour. Similarly, the user activation of a user trial offer may be tracked, for instance. As described above, the tracked information may be transmitted to a database where it is stored and analyzed. The analyzed data may be used to improve customer satisfaction and product offerings.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A graphical user interface (GUI) for setting up a computer system at startup comprising:
a first plurality of on-screen selectable icons, wherein each of said first plurality of on-screen selectable icons is associated with at least one respective setup procedure that when invoked causes a processor to execute an associated setup functionality;
a first visual indicator operable to identify one of said first plurality of on-screen selectable icons responsive to a user selection thereof;
a second visual indicator operable to identify a completion of a setup procedure associated with said user selection of said one of said first plurality of on-screen selectable icons; and
a plurality of on-screen navigational icons for navigating through said first plurality of on-screen selectable icons, for canceling a selection and for exiting a startup user experience.

2. The GUI as described in claim 1 further comprising:
a second plurality of on-screen selectable icons associated with said user selection of one of said first plurality of on-screen selectable icons, wherein each of said second plurality of on-screen selectable icons is associated with a common setup procedure type.

3. The GUI as described in claim 2 further comprising:
a third visual indicator operable to identify one of said second plurality of on-screen selectable icons responsive to a user selection thereof.

4. The GUI as described in claim 3, wherein said third visual indicator is the same as said first visual indicator.

5. The GUI as described in claim 2 further comprising:
a third visual indicator operable to identify a completion of a setup procedure associated with said user selection of one of said second plurality of on-screen selectable icons.

6. The GUI as described in claim 5, wherein said third visual indicator is the same as said second visual indicator.

7. The GUI as described in claim 1, wherein said first visual indicator and said second visual indicator are selected from a group consisting of flashing icons, highlighted icons, bolded text within icons, change of text fonts within icons and a checkmark in close proximity of said first plurality of on-screen selectable icons.

8. A computer system comprising:
a processor coupled to a bus;
a memory coupled to said bus and for storing instructions and data thereon for execution by said processor to implement a graphical user interface (GUI) for setting up said computer system at startup, said GUI comprising:
a first plurality of on-screen selectable icons, wherein each of said first plurality of on-screen selectable icons is associated with at least one respective setup procedure that when invoked causes said processor to execute an associated setup functionality;
a first visual indicator operable to identify one of said first plurality of on-screen selectable icons responsive to a user selection thereof;
a second visual indicator operable to identify a completion of a setup procedure at startup associated with said user selection of said one of said first plurality of on-screen selectable icons; and
a plurality of on-screen navigational icons for navigating through said first plurality of on-screen selectable icons, for canceling a selection and for exiting said startup said GUI; and
a plurality of setup procedures stored in said memory.

9. The computer system as described in claim 8 wherein said GUI further comprises:
a second plurality of on-screen selectable icons associated with said user selection of one of said first plurality of on-screen selectable icons, wherein each of said second plurality of on-screen selectable icons is associated with a common setup procedure type.

10. The computer system as described in claim 9 wherein said GUI further comprises:
a third visual indicator operable to identify one of said second plurality of on-screen selectable icons responsive to a user selection thereof.

11. The computer system as described in claim 10, wherein said third visual indicator is the same as said first visual indicator.

12. The computer system as described in claim 9 wherein said GUI further comprises:
a third visual indicator operable to identify a completion of a setup procedure at startup associated with said user selection of one of said second plurality of on-screen selectable icons.

13. The computer system as described in claim 12, wherein said third visual indicator is the same as said second visual indicator.

14. The computer system as described in claim 8, wherein said first visual indicator and said second visual indicator are selected from a group consisting of flashing icons, highlighted icons, bolded texts within icons, change of text fonts within icons and a checkmark in close proximity of said first plurality of on-screen selectable icons.

15. A computer readable medium comprising instructions that when executed implement a method for rendering a graphical user interface (GUI) for setting up a personal computer (PC) at startup, said method comprising:
displaying a first plurality of on-screen selectable icons, wherein each of said first plurality of on-screen selectable icons is associated with at least one respective setup procedure at startup that when invoked causes a processor to execute an associated setup functionality;
responsive to a user selection of one of said first plurality of on-screen selectable icons, displaying a first visual indicator operable to identify one of said first plurality of on-screen selectable icons responsive to a user selection thereof;
responsive to a completion of a setup procedure at startup associated with said user selection of said one of said first plurality of on-screen selectable icons, displaying a second visual indicator to identify said completion of said setup procedure; and
displaying a plurality of on-screen navigational icons for providing user navigation through said first plurality of on-screen selectable icons, for canceling a selection and for exiting a startup user experience.

16. The computer readable medium as described in claim 15 wherein said method further comprises:
displaying a second plurality of on-screen selectable icons associated with said user selection of one of said first plurality of on-screen selectable icons, wherein each of said second plurality of on-screen selectable icons is associated with a common setup procedure type.

17. The computer readable medium as described in claim 16 wherein said method further comprises:
in response to a user selection of one of said second plurality of on-screen selectable icons, displaying a third visual indicator to identify said user selection of said one of said second plurality of on-screen selectable icons.

18. The computer readable medium as described in claim 17, wherein said third visual indicator is the same as said first visual indicator.

19. The computer readable medium as described in claim 16 wherein said method further comprises:
displaying a third visual indicator operable to identify a completion of a setup procedure at startup associated with said user selection of one of said second plurality of on-screen selectable icons.

20. The computer readable medium as described in claim 15, wherein said third visual indicator is the same as said second visual indicator.
